(19) United States
(12) Patent Application Publication
(10) Pub. No.: US 2019/0061655 A1
(43) Pub. Date: Feb. 28, 2019

(54) METHOD AND APPARATUS FOR MOTION SICKNESS PREVENTION

(71) Applicant: Alpine Electronics, Inc., Tokyo (JP)

(72) Inventor: Hyunji Son, Torrance, CA (US)

(73) Assignee: Alpine Electronics, Inc.

(21) Appl. No.: 15/684,648

(22) Filed: Aug. 23, 2017

(51) Int. Cl. B60R 16/037; B60R 1/00; B60Q 3/70; H04N 13/00

(52) U.S. Cl. CPC B60R 16/037; B60R 1/00; B60R 2300/20; H04N 13/0022; B60R 2300/70; B60Q 3/70

(57) ABSTRACT

A method and apparatus for preventing motion sickness of vehicle occupants are designed to display a motion image in a vehicle interior to convey visual information to the occupants regarding the vehicle's current and upcoming movements. The motion image typically includes a plurality of patterns with the same shape and different sizes arranged concentrically to create a three-dimensional image based on perspective representation, and changes the patterns in advance of upcoming vehicle movements. Thus, the occupants can perceive such moving patterns in their peripheral vision and consciously or unconsciously process and anticipate the vehicle movements, thereby enabling them to avoid or mitigate the experience of motion sickness.

### FIELD OF THE INVENTION

This invention relates to a method and apparatus to prevent motion sickness in a vehicle. More particularly, this invention relates to a method and apparatus to prevent vehicle occupants from experiencing motion sickness, by displaying images or patterns in the interior of the vehicle that correlate with the vehicle motion, road conditions and obstacles encountered during travel, in order to aid the vehicle occupants to anticipate the vehicle's upcoming motion.

### BACKGROUND OF THE INVENTION

Motion sickness is a condition marked by symptoms of nausea, dizziness, and other physical discomfort, and can be associated with various modes of transportation such as cars, boats, aircrafts, etc. A person may experience motion sickness when there is incongruity between the motion a person senses with the inner ear and the motion that the person anticipates or perceives visually. In other words, motion sickness is caused by the mixed signals sent to the brain by the eyes and the inner ear (semicircular canals or vestibular system), and the person's frustrated expectation of movement.

The phenomenon of motion sickness is well known, especially for passengers in the rear seat of an automobile where the view of the road ahead is obstructed. In contrast, it is known that drivers and passengers in the front seat do not experience motion sickness to the same extent as occupants in the rear by comparison. Drivers and front seat occupants do not experience motion sickness as commonly or as severely as occupants in the rear, because they typically have a wide and unobstructed view of the road, and thus a clear visual perception of the vehicle's current and upcoming movements. Further, drivers do not experience motion sickness as commonly or severely as non-driver front seat occupants, because drivers have control of the vehicle, consciously determine the timing and direction of the vehicle movement, and are actively paying attention to the vehicle motion. Accordingly, drivers readily anticipate upcoming motion and can prepare for it, thereby avoiding expectation gap and unexpected physical movement that may be experienced by passengers in the rear and even the front seat.

The need for solutions for motion sickness has become more pronounced in recent years given the various trends and advancements in vehicle technology and social preferences. Many larger automobiles of today commonly have third row seating to accommodate more passengers. Such third-row passengers are further in the back of the automobile, and have a limited and even more obstructed view of the road, and thus are more susceptible to motion sickness. Further, recent advances in self-driving (autonomous) vehicles have brought increased attention to the issue of motion sickness, where vehicle occupants will no longer need to pay attention to the road, and the vehicle itself determines how to drive, the angle and speed of turn, etc. In self-driving vehicles, the occupants are free to do other things such as read, watch videos on tablets or laptops, etc., which renders them more prone to experience mismatch between visual input and the motion sensed by the inner ear, thereby causing motion sickness.

Thus, there is a need for a new method and apparatus for preventing or minimizing motion sickness of vehicle occupants that is effective yet simple and low cost, and which can be implemented in traditional vehicles as well as self-driving vehicles.

### SUMMARY OF THE INVENTION

It is, therefore, an object of the present invention to provide a method and apparatus to reduce the frequency and severity of motion sickness experienced by vehicle occupants, by displaying immersive motion images in the vehicle interior.

It is another object of the present invention to provide a method and apparatus for preventing or mitigating motion sickness of vehicle occupants by creating a sense of anticipation of motion through surrounding the occupants with images or patterns representing upcoming vehicle motion, in order to promote alignment of the motion sensed by the vestibular system of each occupant with immersive visual input.

It is a further object of the present invention to provide a method and apparatus for preventing passengers of a vehicle from experiencing motion sickness by displaying patterns or images that help the passengers anticipate the vehicle's current and upcoming movements.

It is a further object of the present invention to provide a method and apparatus for preventing motion sickness of vehicle occupants by displaying images or patterns in a manner of perspective representation that correspond with and illustrate the current and upcoming vehicle movements.

It is a further object of the present invention to provide a method and apparatus for preventing motion sickness of vehicle occupants by changing the density and dimensions of the images or patterns to realistically reflect upcoming vehicle movements in real time.

One aspect of the present invention is a method for preventing motion sickness of vehicle occupants. The method includes the steps of: calculating, by a central processing unit, a route guidance operation of a navigation unit for guiding a vehicle through a calculated route; analyzing an upcoming maneuver on the calculated route; generating, by a sensor unit, signals related to movements of the vehicle and conditions around the vehicle; analyzing the signals from the sensor unit to determine movements of the vehicle; producing data for displaying a motion image that provides three dimensional perspective cues to an occupant that represent the movements of the vehicle traversing the upcoming maneuver under the conditions in advance of the upcoming maneuver; and displaying, by a display device, the motion image in the interior of the vehicle in advance of the vehicle traversing the upcoming maneuver to allow the occupant to anticipate the upcoming maneuver.

In the method of the present invention, the motion image includes a plurality of patterns of substantially identical shape and varying dimensions that are concentrically arranged or appear to emanate from a singularity. The plurality of patterns in the motion image dynamically change dimensions in order to represent upcoming vehicle movements which simulate a tunnel effect.

In the method of the present invention, the step of displaying the motion image includes a step of regulating the distribution of the patterns in the motion image to correspond with the movements of the vehicle, such as velocity, acceleration, deceleration and change in heading, etc., in a manner of perspective representation.

In the method of the present invention, the step of displaying the motion image includes a step of maintaining a fixed distribution of patterns in the motion image when the vehicle is moving forward in a substantially straight line with a constant speed, such as on a highway. Further, the step of displaying the motion image includes a step of varying the distribution of patterns in the motion image when the vehicle is accelerating or decelerating. To portray acceleration in forward motion, patterns in the outer portion of the motion image as perceived by a vehicle occupant are distributed at a higher density, while patterns appearing in the inner region of the motion image are distributed at lower density. Conversely, to portray deceleration, patterns in the inner portion of the motion image as perceived by a vehicle occupant are distributed at a lower density, while patterns appearing in the outer region of the motion image are distributed at a higher density.

In the method of the present invention, in order to convey a change in heading of the vehicle such as a right or left turn, the step of displaying the motion image includes a step of varying the distribution of patterns in the motion image from left to right or right to left. In the case of a right turn, patterns in the right portion of the motion image as perceived by a vehicle occupant are distributed at a higher density, while patterns appearing in the left region of the motion image are distributed at lower density. Conversely, to portray left turns, patterns in the left portion of the motion image as perceived by a vehicle occupant are distributed at a higher density, while patterns appearing in the right region of the motion image are distributed at a lower density.

In the method of the present invention, the motion image further includes a plurality of perspective lines that extend from an inner area of the motion image to an outer area of the motion image thereby enhancing the three-dimensional impression of the motion image.

The method of the present invention further includes a step of capturing outside views in front of the vehicle by a video camera, and the motion image is comprised of images captured by the video camera. The display device is a video projector attached to an upper area of the vehicle or a plurality of LEDs formed on interior surfaces of the vehicle.

Another aspect of the present invention is an apparatus for preventing motion sickness of vehicle occupants. The apparatus includes: a sensor unit that generates signals related to movements of the vehicle and conditions around the vehicle; a processor that controls an overall operation of the apparatus; and a display device to display images in the interior of the vehicle; wherein the processor is configured to conduct the following operations of: calculating, by a central processing unit, a route guidance operation of a navigation unit for guiding a vehicle through a calculated route; analyzing an upcoming maneuver on the calculated route; analyzing the signals from the sensor unit to determine actual movements of the vehicle; producing data for displaying a motion image that provides three dimensional perspective cues to an occupant that represent the movements of the vehicle traversing the upcoming maneuver under the conditions in advance of the upcoming maneuver; and causing the display device to display the motion image in the interior of the vehicle in advance of the vehicle traversing the upcoming maneuver to allow the occupant to anticipate the upcoming maneuver. Each of the above noted components is further uniquely configured to perform the operational steps defined in the method invention detailed above.

According to the present invention, the method and apparatus for preventing motion sickness are designed to project or display a motion image on an interior of a vehicle in a manner to send visual information to occupants of the vehicle regarding the vehicle's current and upcoming movements. Such a motion image typically includes a plurality of patterns concentrically arranged in a manner of perspective representation, i.e., as a three dimensional shape, and changes the pattern in real time in response to the current and upcoming vehicle movements. Thus, even though the occupants of the vehicle may not be paying attention to the vehicle movements but are rather, for example, reading or watching other media, the occupants can perceive such moving patterns in their peripheral vision and visualize vehicle movements, thereby enabling them to avoid motion sickness.

### BRIEF DESCRIPTION OF THE DRAWINGS

FIG. 1 is a table detailing severity levels of motion sickness experienced by the vehicle driver, front seat passenger, and rear seat passengers, as related to the physical sensation, perceived visual information and sensation of control of each respective vehicle occupant.

FIG. 2A is a perspective view showing an inside of a vehicle where an occupant is sitting in a rear seat of the vehicle without paying attention to the views of the road ahead.

FIG. 2B shows the same perspective view of FIG. 2A, and further illustrates a motion image of the present invention displayed on interior surfaces of the vehicle to prevent motion sickness, where the vehicle is moving straight forward with a constant speed.

FIGS. 3A-3D are schematic diagrams illustrating the chronological animation of patterns in the motion image when the vehicle is moving in a substantially straight forward direction at a constant speed.

FIG. 4 is a schematic diagram showing an example of the motion image to be used in the present invention comprising four rectangular shape patterns to illustrate how the motion is visually simulated by simple modification of the rectangular shape patterns.

FIG. 5A is a chronological illustration of an example of the vehicle approaching and making a right turn, with a schematic overhead view of the changing motion image of the present invention.

FIG. 5B is a perspective view showing the motion image of the present invention corresponding to the right turn motion illustrated in FIG. 5A.

FIGS. 6A and 6B are step-by-step diagrams of a route navigation operation with corresponding schematic diagrams and vehicle cross-section or overhead view showing an example of the various motion images shown in the vehicle over the course of route guidance on a calculated route.

FIGS. 7A and 7B are directed to the case in which the vehicle avoids colliding with a pedestrian by making a sudden right turn, where FIG. 7A is a plan view schematically showing the right turn of the vehicle, and FIG. 7B is a perspective view showing the motion image of the present invention representing the acute right turn of the vehicle and an image representing the pedestrian, which is the reason of the abrupt right turn.

FIGS. 8A-8H are schematic diagrams showing example motion images of the present invention to be displayed in the vehicle interior, where FIG. 8A illustrates the motion image when the vehicle is moving forward in a constant speed, FIG. 8B illustrates the motion image when the vehicle is making a left turn, FIG. 8C illustrates the motion image when the vehicle is accelerating, FIG. 8D illustrates the motion image when the vehicle is decelerating, FIG. 8E illustrates the motion image when the vehicle is moving downhill, FIG. 8F illustrates the motion image incorporating changes in color or brightness when the vehicle is making a right turn, FIG. 8G shows a plurality of patterns composed of solid lines and varying line weights, and FIG. 8H shows a plurality of patterns composed of dotted lines and varying line weights

FIGS. 9A-9H are schematic diagrams showing another set of motion images of the present invention to be displayed in the vehicle interior where each image includes perspective lines that enhance the three-dimensional and realistic representation to the vehicle occupants. FIG. 9A illustrates the motion image when the vehicle is moving forward in a constant speed, FIG. 9B illustrates the motion image when the vehicle is accelerating, FIG. 9C illustrates the motion image when the vehicle is decelerating, FIG. 9D illustrates the motion image when the vehicle is moving uphill, FIG. 9E illustrates the motion image when the vehicle is moving downhill, FIG. 9F illustrates the motion image when the vehicle is traversing turbulent conditions, FIG. 9G illustrates the motion image when the vehicle is making a left turn, and FIG. 9H illustrates the motion image when the vehicle is making a hard swerve to the left.

FIGS. 10A-10C are schematic diagrams showing further examples of motion images of the present invention that may be displayed in the vehicle interior, where FIG. 10A shows a plurality of patterns each having an oval shape arranged in a perspective representation, FIG. 10B shows a plurality of patterns each having a semi-circular shape arranged in a perspective representation, and FIG. 10C shows a plurality of ball shapes appearing to emanate from a singularity.

FIGS. 11A-11C are vehicle side views illustrating example of positions for a display device and display areas for the motion images of the present invention, where in FIG. 11A, a projector is mounted on a ceiling at about the midpoint between the front seat and the back seat while in FIG. 11B, the projector is mounted further back on the vehicle ceiling, and in FIG. 11C, a plurality of LEDs are implemented on interior surfaces as a display device.

FIG. 12 is a schematic diagram showing an example of a triple-axis accelerometer that can be mounted on the vehicle implementing the motion sickness prevention method and apparatus of the present invention.

FIG. 13 is a top view showing positions of cameras to capture wide views in front of and around the vehicle implementing the motion sickness prevention method and apparatus of the present invention.

FIG. 14 is a schematic block diagram showing an example of functional components in the motion sickness prevention apparatus of the present invention.

FIG. 15 is a flow chart showing basic steps of the method for preventing motion sickness by displaying the motion image in accordance with the present invention.

FIG. 16 is a flow chart showing basic steps of another embodiment of the method for preventing motion sickness by displaying the motion image in accordance with the present invention.

FIG. 17 is a flow chart showing more detailed steps related to the steps 101 and 102 of FIG. 16 to determine the vehicle movements in accordance with the present invention.

### DETAILED DESCRIPTION OF THE PREFERRED EMBODIMENTS

The present invention will be described in detail with reference to the accompanying drawings. The method and apparatus for preventing motion sickness in the present invention are designed to display a motion image in an interior of a vehicle in a manner to send visual information to occupants of the vehicle regarding the vehicle's current and upcoming movements. Such a motion image typically includes a plurality of patterns concentrically arranged or apparently emerging from a singularity in a manner of perspective representation, e.g., as a three dimensional shape, and the patterns change in density and dimension in order to convey upcoming motion information to assist vehicle occupants in anticipating vehicle motion and maneuvers before being processed by the occupants' vestibular system. Thus, even though the occupants of the vehicle may not be paying attention to the vehicle movements and are instead engaged in other activities such as reading, watching videos, etc., the occupants can perceive such moving patterns via their peripheral vision and visualize vehicle movements, thereby enabling them to avoid motion sickness. The present invention for preventing motion sickness is advantageously implemented in traditional vehicles that require a driver, as well as autonomous, self-driving vehicles.

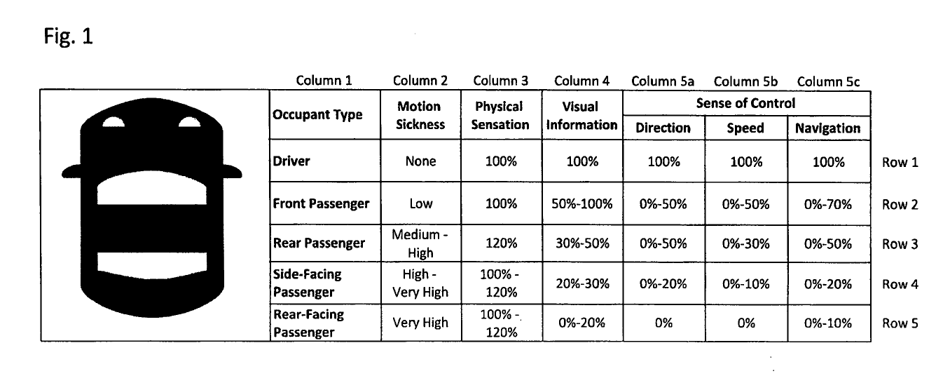

FIG. 1 is a table summarizing levels of susceptibility to motion sickness as correlated with physical sensation, visional information, and sense of control of vehicle occupants seated in different positions in a vehicle. Column 1 lists various vehicle occupant types: driver, front passenger, rear passenger, side-facing passenger, and rear-facing passenger. Typical modern vehicles provide seating for drivers, front passengers, and rear passengers who are all facing forward. A s autonomous driving vehicles are adopted, more seating variations will be possible as there will no longer be a need for a driver or for any occupant to be facing forward. Further, autonomous vehicles will no longer require unobstructed views for drivers, and vehicle arrangements optimized for non-driving activities will become available. The present invention may be implemented in current vehicles as well as partially and fully autonomous driving vehicles in order to mitigate motion sickness of any vehicle occupant, regardless of seating position or level of attention to the vehicle motion.

Column 2 lists the likelihood or severity level of motion sickness experienced by each occupant type. Referring to Row 1, the driver has the lowest susceptibility to motion sickness, whereas compared to Row 5, a rear-facing passenger has a very high level of susceptibility.

Column 3 lists the level of physical sensation experienced by each occupant. In general, all occupants experience 100% physical sensation. However, occupants seated in the rear of the vehicle may experience “bumpy” or “jerky” rides, and thus may experience physical sensation in excess of 100%.

Column 4 lists the degree of visual information available to each occupant type. The visual information experienced by occupants other than the driver varies depending on the direction of the occupant's view, as well as how much the occupant is paying attention to the exterior of the vehicle. For example, a Front Passenger in a traditional vehicle may have the same level of visual information as the driver (100%) due to the full frontal view of the front seat. However, since the Front Passenger does not need to pay attention to the road, his visual information may be less than 100%.

Columns 5a, 5b, 5c each list the level or range of levels each occupant type may experience for various aspects of motional information that contribute to the occupant's sense of control. Drivers typically experience little to no motion sickness because not only do they have parity of visual information perceived by the eyes and motion information sensed by the vestibular system, but also because drivers have full sense of control of the vehicle with respect to direction, speed and navigation (i.e. active awareness of the route to destination).

Grouped under the Sense of Control category, for each occupant type Column 5a lists the degree of awareness of vehicle direction, Column 5b lists the degree of awareness of vehicle speed, and Column 5c lists the degree of awareness of navigation (i.e. route to destination).

By comparing Rows 1-5 for each occupant type, it becomes clear that the driver, who experiences both physical sensation and visual information at 100%, as well as 100% for each aspect of sense of control, has no or low risk for motion sickness. On the other hand, as shown in Row 5, a rear facing passenger has a very high risk for motion sickness as such occupant scores very low on visual information and sense of control categories, while experiences physical sensation at 100% or over.

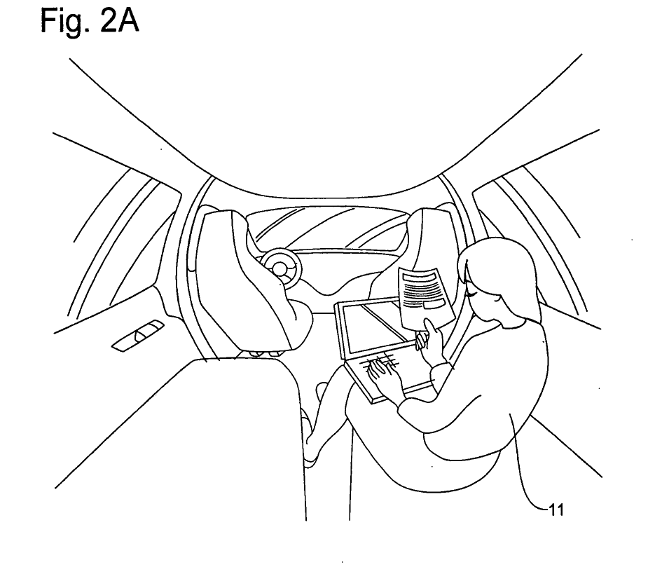

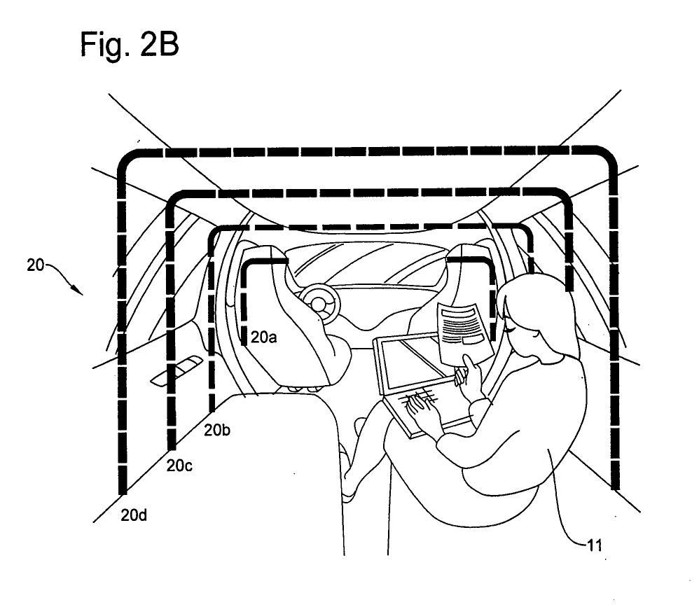

FIG. 2A is an illustration of an inside of a vehicle where an occupant 11 sits on a rear seat. In this example, since the vehicle is an autonomous, self-driving vehicle, the occupant 11 need not pay attention to the view of the road ahead. Since motion sickness is caused when the motion sensed by the inner ear of occupant 11 is different from the motion that she visualizes, the vehicle occupant 11 may experience motion sickness. The risk of experiencing motion sickness is further compounded as the occupant 11 is reading a document and using a laptop computer, and is not actively in control or aware of the changing vehicle motions. With reference to FIG. 1, such an occupant 11 is characterized as a Rear Passenger (Row 3) with medium-high susceptibility to motion sickness.

FIG. 2B is an illustration of an example of a motion image 20 for motion sickness prevention of the present invention as displayed in the vehicle interior of FIG. 2A. In this example, the motion image is composed of a plurality of concentrically arranged patterns 20a, 20b, 20c, 20d each having a rectangular shape, and is animated to surround the occupant and simulate motion through a tunnel. Each of the patterns 20a-20d is animated in a three-dimensional perspective representation that visually simulates approach to or recession from the vehicle occupant 11 in accordance with the actual upcoming vehicle motion, and creates a perception of movement in the occupant 11 as if the occupant were traversing a tunnel.

In this example, the patterns 20a-20d are rectangular in shape, and are displayed on the side walls, roof and other features of the vehicle interior. However, such motion image 20 may also include portions displayed on the vehicle floor, or selectively displayed on specific interior surfaces or areas. Due to the complexity and variation of vehicle surfaces, the patterns of the motion image may be preferably adapted to specific vehicle interiors, provided that the totality of the motion image displayed in the vehicle interior will be sufficient to provide visual information of the vehicle movements to the occupant 11.

In the example of FIG. 2B, the patterns 20a-20d in the motion image 20 are substantially symmetrical and distributed at a constant distance (width) between each adjacent two patterns, indicating that the vehicle is moving straight forward with a constant speed. Since the motion image 20 is distributed throughout the vehicle interior, the motion image 20 surrounds the occupant 11, enters the peripheral vision of the occupant 11, and enables her to visualize the vehicle's motion, even when the occupant 11 is not looking ahead, the occupant's 11 view of the outside of the vehicle is obstructed, or the occupant 11 is otherwise not paying attention to the vehicle. In other words, the motion image 20 is displayed in a wide area of the interior of the vehicle so that the occupant 11 visually senses the motion through her peripheral vision.

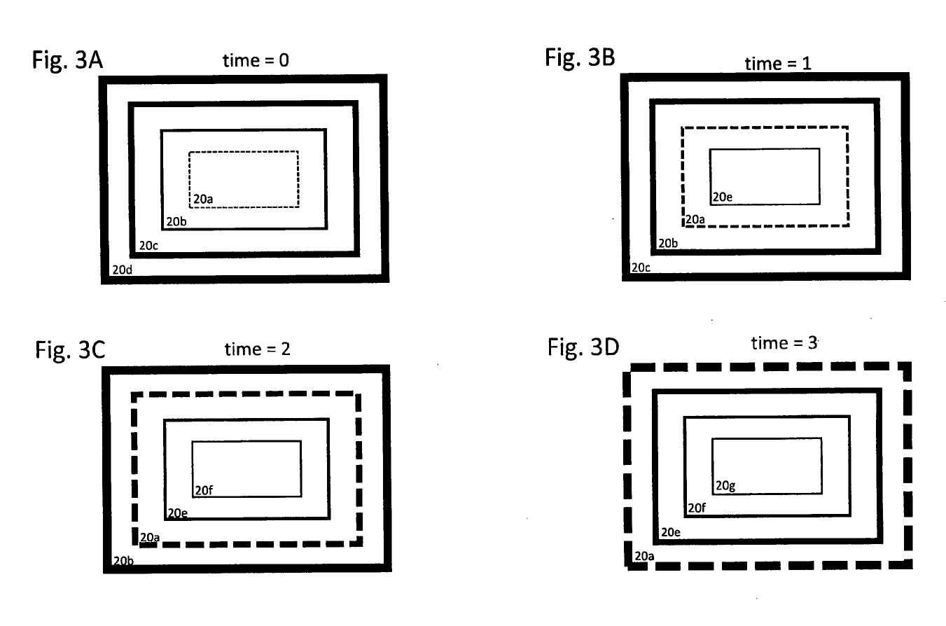

FIGS. 3A-3D are schematic drawings of animation frames of the motion image displayed in the vehicle interior as contemplated by the present invention. In this example, the motion image simulates forward motion through a tunnel, and thus corresponds with actual upcoming forward motion of the vehicle. To illustrate the animation effect perceived by vehicle occupant 11 over time, FIGS. 3A-3D show the progression of pattern 20a as it approaches the vehicle occupant 11 from a farther area of the vehicle interior to an area closer to the vehicle occupant 11. For illustration purposes, pattern 20a is depicted as a dotted line while the other patterns 20b-20g are shown as solid lines, however in actual implementation, all patterns may be all the same line type, such as all solid, all dotted, etc., or a combination of various types based on user preference or other settings.

FIG. 3A illustrates the first frame of the motion image 20 at time=0. In this example, pattern 20a appears farthest from occupant 11. In FIG. 3B, time=1 and patterns 20a-20c have each advanced toward the occupant 11 and increased in size, while a new pattern 20e appears where pattern 20a was located at time=0, and pattern 20d is no longer visible, simulating that the occupant has passed pattern 20d. FIG. 3C depicts the motion image at time=2, where patterns 20a, 20b and 20e have each advanced towards the occupant 11 and increased in size, pattern 20c is no longer visible, and a new pattern 20f appears where pattern 20e was located at time=1. In FIG. 3D at time=3, patterns 20a-20f have advanced towards the occupant 11 and increased in size, pattern 20b is no longer visible, and a new pattern 20g has appeared where pattern 20f was located at time=2.

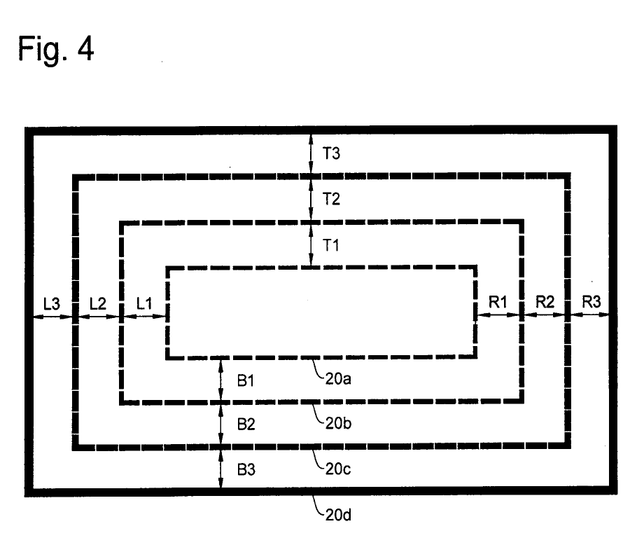

The patterns 20a-20g of the motion image as shown in FIGS. 3A to 3D are continuously animated to provide a visual sense of motion to the occupant 11 of the vehicle. While only four image frames are shown in FIGS. 3A-3D in order to illustrate the motion image of the present invention, more image frames may be displayed to provide a smooth animation that gives a sense of movement in actual embodiments, for example, 20 frames per second or more. While higher frame rates demand greater computer resources, in the present invention, the motion image comprising multiple patterns can be generated without a high demand on computer resources, as will be described later with reference to FIG. 4.

The above example of FIG. 2B illustrates a motion image displayed in a vehicle when the vehicle moves forward at a constant speed. Such motion image can be generated in real time or in advance of maneuvers along a calculated route in order to represent various vehicle movements and other conditions, such as left or right turns, progression uphill or downhill, sudden stops or acceleration, etc., thereby providing visual feedback to the occupants and allowing them to anticipate the upcoming motion. Allowing the vehicle occupants to anticipate the vehicle motion can mitigate or avoid motion sickness, because the visual input serves not only as visual information to the occupant, but also contributes to the occupant's sense of control of the vehicle motion.

FIG. 4 is a schematic diagram illustrating how the motion image may be generated by simple modification of the rectangular shapes. In FIG. 4, four rectangular shapes 20a, 20b, 20c, 20d are shown. The rectangular shape 20a, which is the smallest rectangular shape, represents the furthest (far-ahead) scenic cue. The rectangular shape 20d, which is the largest rectangular shape, represents the scenic cue closest (nearest) to the occupant. The rectangular shape 20d encloses the rectangular shapes 20c, 20b, 20a. The rectangular shape 20c is the next nearest rectangular shape enclosed by the rectangular shape 20d. The rectangular shape 20c encloses the third nearest rectangular shape 20b, which in turn encloses the farthest shape 20a.

The width (distance) between the adjacent rectangular shapes, at its four edges are represented by arrows between the adjacent rectangular shapes. At the left side, L1 represents the width between the left edge of the rectangular shape 20a and the left edge of the rectangular shape 20b. Similarly, L2 represents the width between the rectangular shapes 20b and 20c, and L3 represents the width between the rectangular shapes 20c and 20d at the left of the rectangular shapes. At the right side, R1 represents the width between the right edge of the rectangular shape 20a and the right edge of the rectangular shape 20b. Similarly, R2 represents the width between the rectangular shapes 20b and 20c, and R3 represents the width between the rectangular shapes 20c and 20d at the right of the rectangular shapes.

At the upper (top) side, T1 represents the width between the top edge of the rectangular shape 20a and the top edge of the rectangular shape 20b. Similarly, T2 represents the width between the rectangular shapes 20b and 20c, and T3 represents the width between the rectangular shapes 20c and 20d at the top of the rectangular shapes. At the lower (bottom) side, B1 represents the width between the bottom edge of the rectangular shape 20a and the bottom edge of the rectangular shape 20b. Similarly, B2 represents the width between the rectangular shapes 20b and 20c, and B3 represents the width between the rectangular shapes 20c and 20d at the bottom of the rectangular shapes.

In FIG. 4, the motion image shows a condition where the vehicle is moving straight in a constant speed similar to the image shown in FIG. 2B. Thus, in FIG. 2B, L1=L2=L3, R1=R2=R3, T1=T2=T3, and B1=B2=B3. However, the widths need not be equivalent in order to convey constant speed, rather, varying widths may be displayed provided that the widths remain constant.

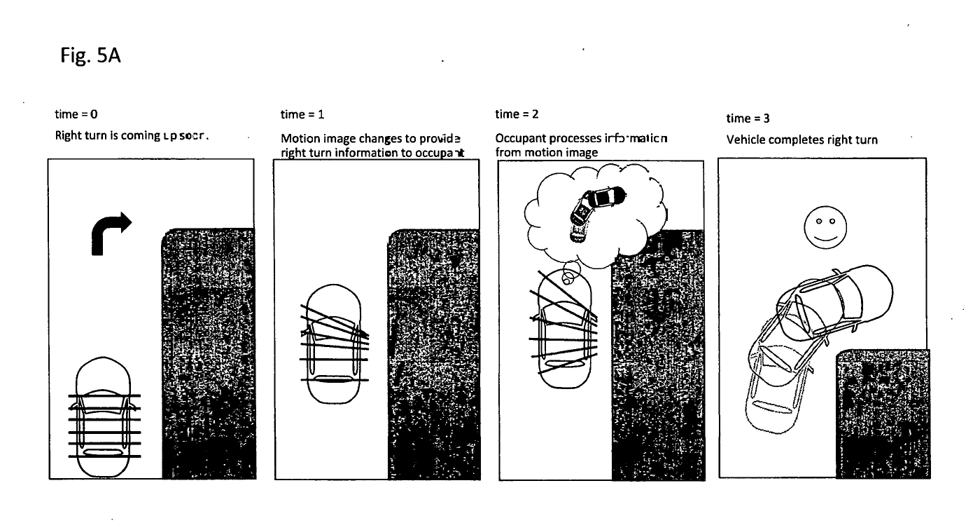

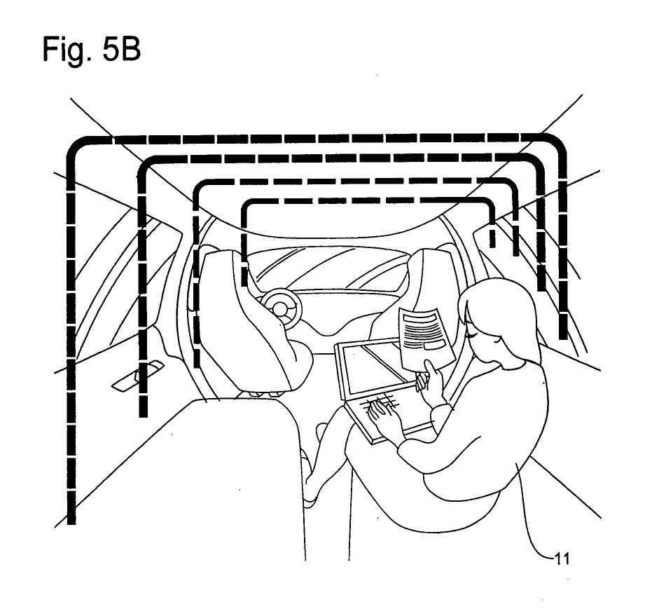

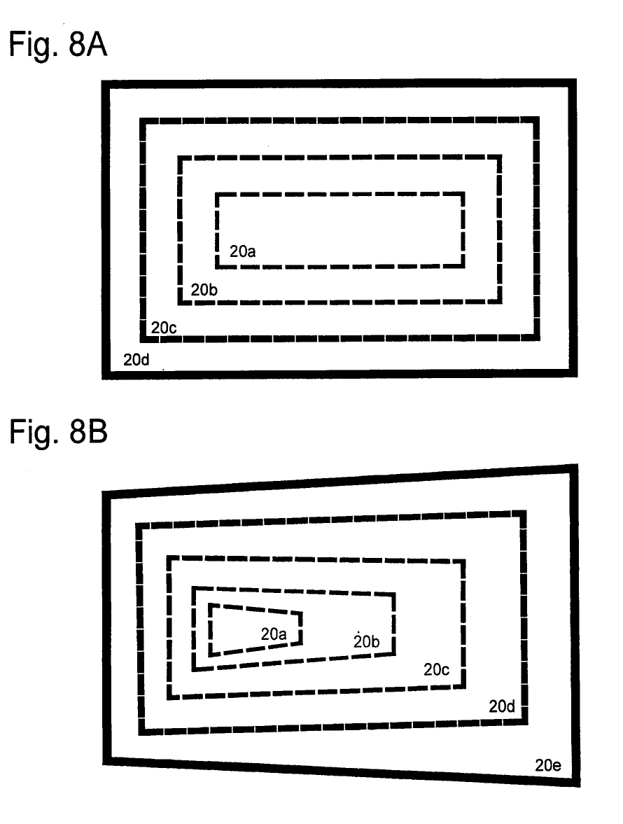

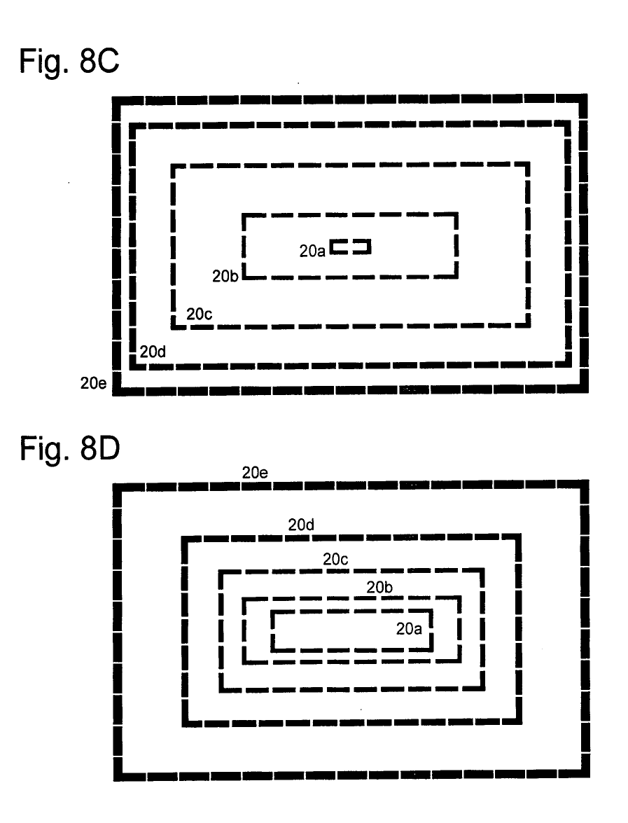

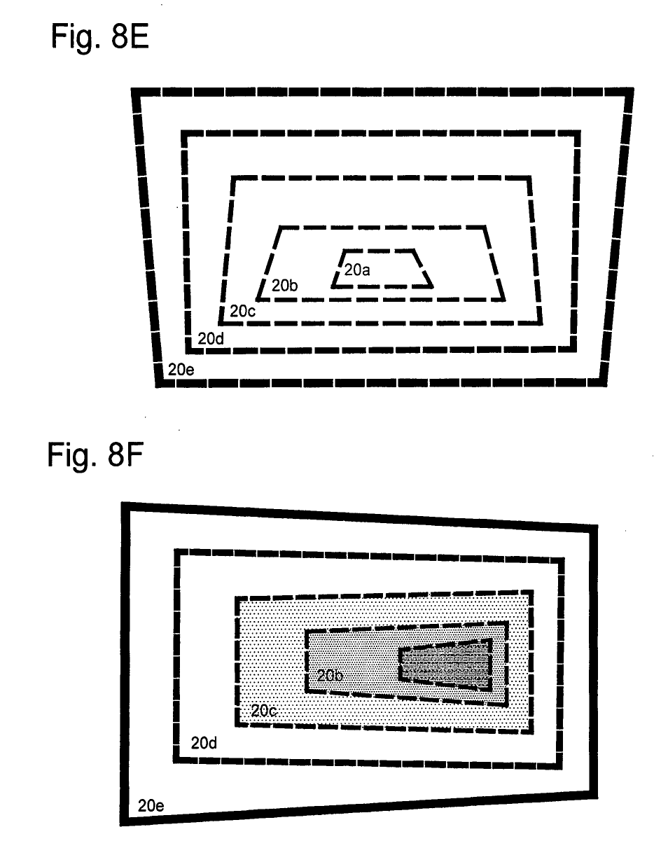

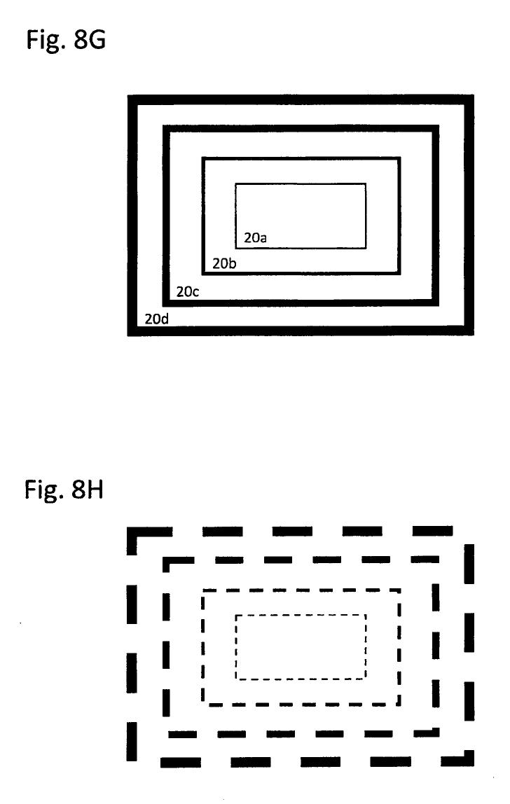

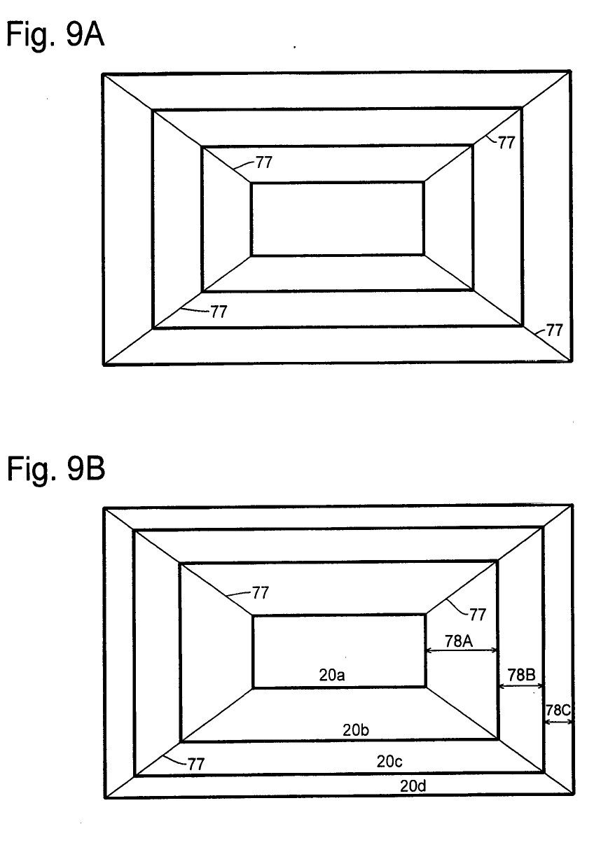

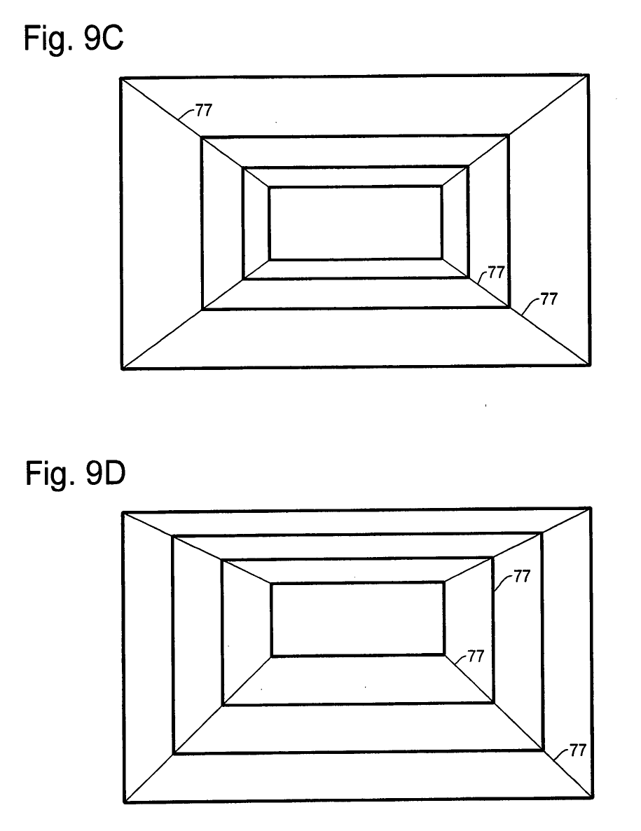

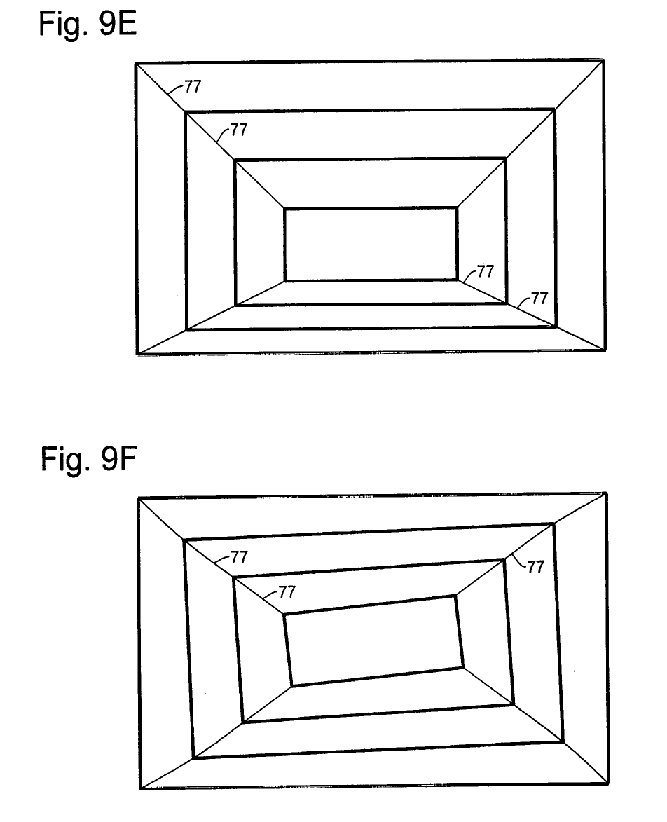

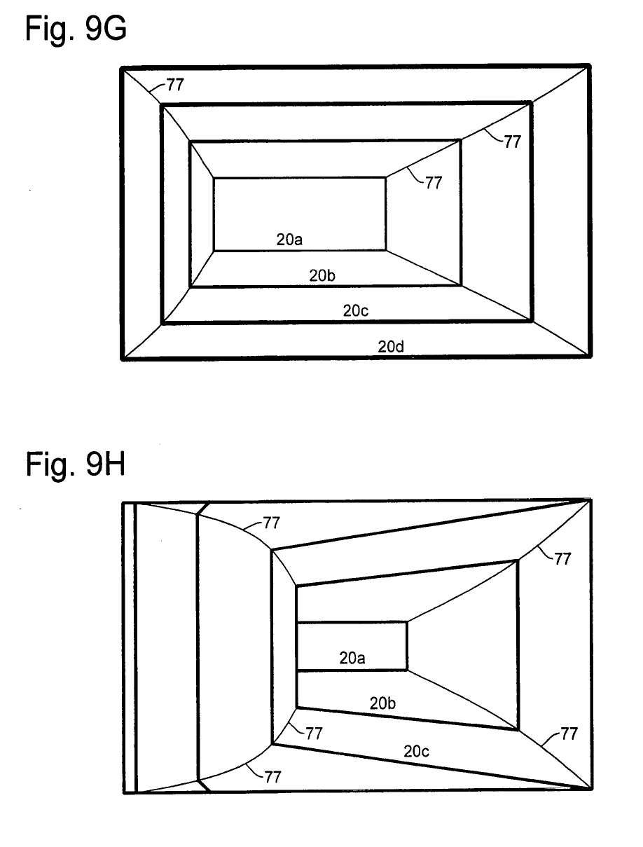

When the turning direction of the vehicle is to the right, as in the case shown in FIGS. 5A-5B, the widths R1, R2, R3 become smaller, while the widths L1, L2, L3 become larger. Moreover, in order to provide scenic cues of turn using patterns in a three dimensional framework, the right edge of the inner rectangular shape 20a (far ahead) may become longer than the left edge of the same rectangular shape, while the right edge of the outer rectangular (closer to the occupant) shape 20d may become shorter than the left edge of the same rectangular shape as shown in FIG. 8F. The rectangular shapes 20b and 20c placed between the rectangular shape 20d and the rectangular shape 20a gradually change the length of both the left and right edges as shown in FIG. 8F. The ratio of the length of edge of the turning direction (right) changes less than the ratio of the length of the edge of the opposite direction (left) of rectangular shapes 20a, 20b, 20c and 20d. In other words, the ratio of the length of edge of the opposite direction (left) of the turning direction changes more than the ratio of the length of the edge of the turning direction (right) of rectangular shapes 20a, 20b, 20c and 20d. While the above description explains the case when the turning direction is to the right, when the vehicle is making a left turn, the widths L1, L2, L3 become shorter, while the width R1, R2, R2 become longer as shown in FIG. 8B. It is also notable that this effect may be accomplished by applying lengthening and shortening of the opposite left/right sides, as shown in FIG. 9H, where the motion image depicts motion to left when the vehicle is making a left turn, and the left edges of each of the rectangular shapes are shorter than the right edges of the respective shapes.

When the vehicle is accelerating, as in the case shown in FIG. 8C, each of the widths between the rectangular shapes 20d and 20c become shorter than the width between the rectangular shapes representing further ahead, such as the rectangular shapes 20a and 20b. That is, the widths T3, R3, B3 and L3 become shorter than the widths T1, R1, B1 and L1. Conversely, When the vehicle is decelerating, as in the case shown in FIG. 8D, each of the widths between the rectangular shapes 20d and 20c become longer than the width between the rectangular shapes representing further ahead, such as the rectangular shapes 20a and 20b. That is, the widths T3, R3, B3 and L3 become longer than the widths T1, R1, B1 and L1. Thus, the width between a larger rectangular shape and a nearest smaller rectangular shape enclosed by the larger rectangular shape is shortened when the vehicle is accelerating, and lengthened when the vehicle is decelerating. The ratio of shortening and lengthening of the width between the edges is more accentuated for the width between larger (nearer) rectangular shapes (i.e., 20c and 20d) than a width between smaller (further) rectangular shapes (i.e., 20a and 20b).

The degree of acceleration and deceleration is preferably reflected in the width between the rectangular shapes. When the acceleration rate is high, the width between the rectangular shapes is shortened more than when the acceleration is low. Similarly, when the deceleration rate is high (sudden stop), the width between the rectangular shapes is widened more than when the deceleration is low. Thus, the change of the width between the larger rectangular shape and a nearest smaller rectangular shape enclosed by the larger rectangular shape is proportional to the acceleration or deceleration of the vehicle.

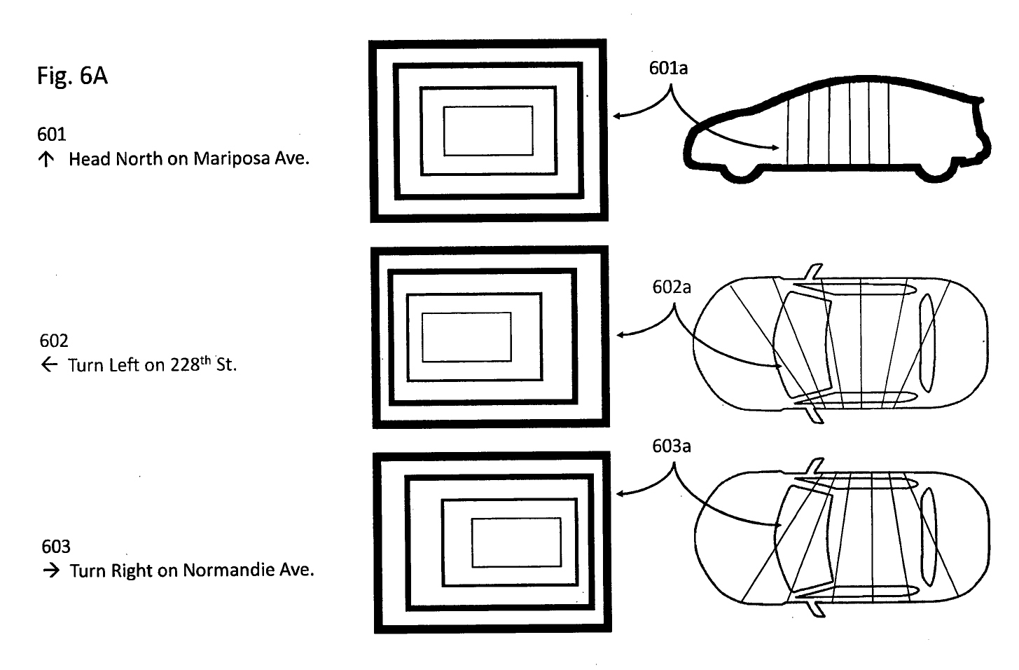

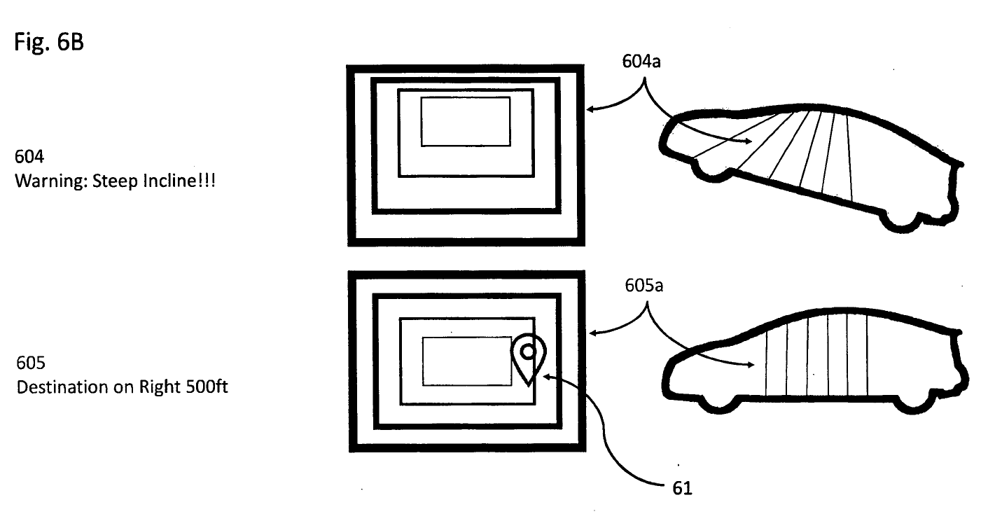

When the vehicle travels downhill, as in the case shown in FIG. 8E, the widths B1, B2, and B3 become shorter, while the widths T1, T2, and T3 become longer. In addition, in order to provide a downhill image in a three dimensional framework, the top edge of the inner rectangular shape may become shorter than the bottom edge of the same rectangular shape, while the top edge of the outer rectangular shape may become longer than the bottom edge of the same rectangular shape. The rectangular shapes 20b and 20c placed between the rectangular shape 20d and the rectangular shape 20a gradually change the length of the both the top and bottom edges inversely as shown in FIG. 6E. While the above description explains the case when the turning direction is to the lower direction (downhill), when the vehicle goes uphill, the width B1, B2, and B3 becomes longer, while the width T1, T2, and T3 becomes shorter. Thus, similar operation as described for moving downhill can be used for the vehicle's movement uphill.

The change of vehicle speed (acceleration or deceleration) is conveyed by the motion image by changing the width between the outer and inner rectangular shapes. In an acceleration phase, the width between outer rectangular shapes is shortened more than the width between inner rectangular shapes. In a deceleration phase, the width between outer rectangular shapes is widened more than the width between inner rectangular shapes. For curves to the left or right, as well as uphill or downhill movement of the vehicle, the angular velocity determined by the IMU (inertial measurement unit) 69 and other sensor devices allows the motion sickness prevention apparatus to quickly generate the motion image in real time or in anticipation of the shape of the upcoming vehicle motion. Also, such road and terrain data may be stored in map data of a navigation system used to perform route guidance for the vehicle. In other words, by determining yaw and/or pitch of the vehicle, or by analyzing the map data, the motion sickness prevention system can quickly generate motion images comprised of multiple rectangular shapes. The method of generating the motion picture image is the same regardless of the turning direction, whether the vehicle is making a left turn, right turn, or going uphill or downhill.

As described above, the animation of simple patterns such as rectangular shapes effectively evoke various vehicle movements, such as acceleration, deceleration or turning. By using multiple rectangular shapes in the motion image that surround or otherwise appear in the vehicle occupant's peripheral vision, the motion sickness prevention apparatus of the present invention is able to generate effective visual cues to the occupants without burdening computer resources. Even when computer resources are limited, the motion image can be generated in advance of maneuvers on a calculated route, in real time without lag, or in anticipation of the vehicle motion, because the motion image is comprised of a plurality of simple shapes and can be generated quickly with simple calculations.

FIG. 5A is a plan view illustrating the process over time of a vehicle making a right turn, with exploded schematic lines overlaid on the vehicle to illustrate an overhead view of the shape and placement of the motion image contemplated by the present invention. At time=0, the vehicle is moving at a constant forward speed, and thus a motion image composed of evenly spaced patterns such as the example in FIG. 2B is displayed in the vehicle.

At time=1, the vehicle is still moving at a constant speed, but is approaching a right turn. In anticipation of the right turn, the motion image begins to transition from evenly spaced patterns to patterns where the width between the right edges narrows, while the width between the left edges widens, such as in FIG. 5B.

At time=2, the vehicle is about to actually make the right turn, and thus the motion image transitions to a more exaggerated pattern such as FIG. 8F, which represents a full right turn where the width between the right edges of the patterns are further narrowed, and the width between the left edges of the patterns are further widened, while lengths of the left edges are shortened in order to simulate that the occupant is moving away from the left.

At time=3, the vehicle is completing the right turn and returning to constant forward motion. During this maneuver, the motion image transitions from the exaggerated right turn of FIG. 8F, to the moderate right turn pattern of FIG. 5B, and then back to the FIG. 2B pattern corresponding to forward constant speed motion. At this point, the occupant has already received visual feedback about the right turn from the motion image, and thus has had time to consciously or subconsciously prepare for the change in motion in advance of the maneuver.

This transition of motion image patterns from time=0 to time=3 signals to the occupant that the vehicle is about to make a right turn, is making a right turn, and exiting a right turn into constant forward motion, respectively, and thereby provides the occupant with visual information to allow the occupant to mentally and physically prepare for the right turn motion, thereby mitigating or avoiding motion sickness.

FIG. 5B is a perspective view illustrating the motion image displayed in the vehicle interior when the vehicle is making a right turn as shown in FIG. 5A. Specifically, the motion image in FIG. 5B corresponds to the motion image displayed at or around t=1 to t=2 in anticipation of the turn actually being made.

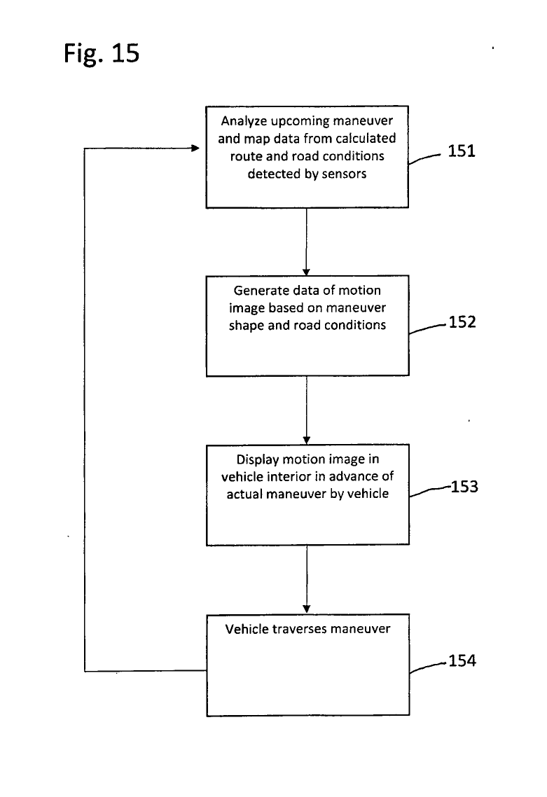

FIGS. 6A and 6B illustrate an example of a vehicle traversing a calculated route while motion images corresponding with upcoming maneuvers are displayed in the vehicle interior as the vehicle approaches each maneuver. In this embodiment, the motion image display system generates motion images in concert with the vehicle navigation system (as further described in detail in FIG. 15.

Current vehicle navigation systems provide drivers with route guidance in advance of a maneuver, in order to allow the driver to adequately prepare for and timely execute the maneuver. Similarly, the motion images of the present invention are displayed to the vehicle occupant in advance of the corresponding maneuvers in order to prepare the occupant for the upcoming motion. Accordingly, the motion image system is advantageously paired with a vehicle navigation system in order to provide route guidance as well as motion sickness mitigation or avoidance. The motion images not only will aid vehicle occupants with visual information and sensation of control in order to avoid motion sickness, but also provide drivers with immersive visual cues for upcoming vehicle maneuvers.

In FIGS. 6A and 6B, a series of route guidance maneuvers generated by a navigation system are shown coupled with examples of motion images representing the vehicle motion. In step 601, the navigation system instructs the driver to “Head North on Mariposa Ave.”, and the corresponding motion image 601a depicts evenly spaced patterns indicating constant forward motion.

At Step 602, the navigation system instructs the driver to “Turn left onto 228^{th} St.,” and the corresponding motion image 602a depicts patterns arranged where the left edge of each pattern is narrowly spaced and the right edge of each pattern is widely spaced in order to convey the feeling of motion to the left.

At Step 603, the navigation system instructs the driver to “Turn right on Normandie Ave.,” and the corresponding motion image 603a depicts patterns arranged where the right edge of each pattern is narrowly spaced and the left edge of each pattern is widely spaced to simulate the feeling of motion to the right.

At Step 604, the navigation system warns the driver of a steep incline, such as on a hill or mountain, and the corresponding motion image 604a depicts patterns where the top edge of each pattern is narrowly spaced and the bottom edge of each pattern is widely spaced in order to simulate the feeling of climbing uphill.

At Step 605, the navigation system provides the driver with information that the destination is on the right in 500 ft, and the corresponding motion image 605a includes a destination marker 61 on the right side of the motion image, and may be animated to increase in size as the vehicle nears in proximity to the actual destination.

Although FIGS. 6A and 6B illustrate an example where the motion image system of the present invention is coupled with a navigation system providing route guidance to a driver, the motion image system may also be advantageously adapted to autonomous driving systems that do not require a human driver. In such an embodiment, the motion image system is coupled with the autonomous driving navigation system, and similarly displays motion images in the vehicle interior that correspond with the upcoming vehicle motions.

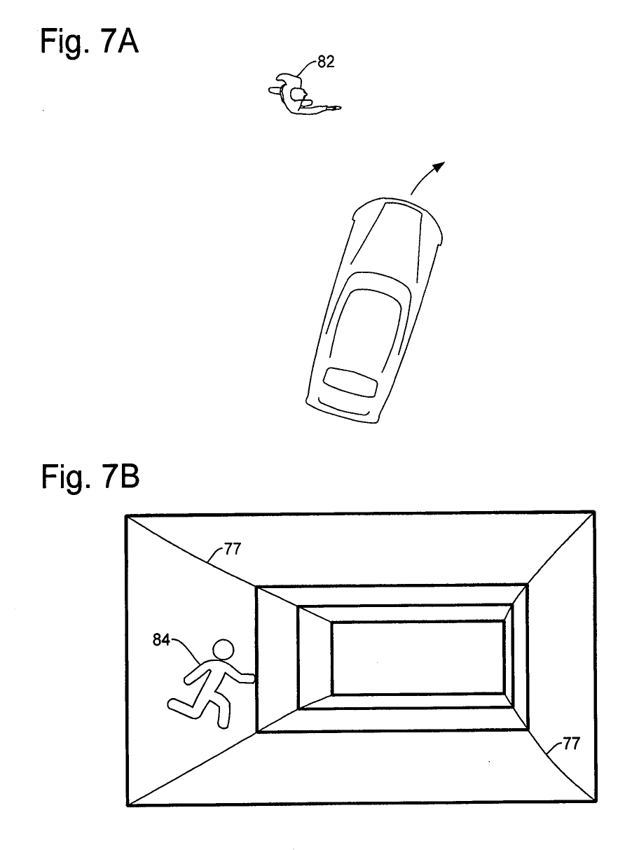

FIGS. 7A and 7B illustrate an example of an unanticipated event which may cause the vehicle to break from a calculated route navigation. In FIG. 7A, the vehicle suddenly swerves sharply to the right in order to avoid collision with a pedestrian 82. Although the extemporaneous vehicle motion is not part of a calculated route, in FIG. 7B a motion image may still be displayed in the vehicle interior to provide the vehicle occupants with visual feedback that conveys not only the vehicle motion, but also a maneuver reason icon 84 that indicates the cause of the unplanned vehicle motion, such as sudden stops, rapid deceleration, sharp turns, etc.

A threshold may be preferably set that determines when the maneuver reason icon 84 should be projected. For example, the threshold value of a rate of acceleration, deceleration or angular velocity of a turn may be predetermined, and if the threshold value is exceeded, the maneuver reason icon 84 is projected. Other maneuver reason icons 84 corresponding to other situations, such as a sudden stop of a front vehicle, an animal on the street, etc., may also be projected.

Alternatively, a video image of the actual exterior conditions causing the unplanned maneuver may be displayed in place of or together with a maneuver reason icon 84. Such video image may be captured with an external vehicle camera and displayed in the vehicle interior by the motion image system.

FIGS. 8A-8H are schematic diagrams showing examples motion images of the present invention to be displayed on the vehicle interior with respect to various movements of the vehicle. The motion images are composed of patterns concentrically arranged and appear to move like tunnel walls in accordance with the vehicle's movement, i.e., become larger when they come closer to the vehicle occupant, and as explicitly shown in FIGS. 8G-8H, the line weight of each pattern preferably increases as the pattern becomes larger, which conveys a sense of increasing proximity to the occupant. It should be noted that because of the complexity of the interior surfaces of the vehicle, in actual application, the motion images displayed in the vehicle interior may be more complex than those of FIGS. 8A-8H.

FIG. 8A illustrates an example motion image displayed when the vehicle is moving straight ahead in a constant speed. As shown in this example, each of the patterns 20a-20d in the image is symmetrical and the width (distance) between the adjacent two patterns is constant. Empirical testing has determined that as long as the speed is constant (no acceleration or deceleration), the motion image of FIG. 8A can be used to convey the sense of constant forward motion to the occupant regardless of rate of speed.

FIG. 8B illustrates an example motion image displayed on the interior of the vehicle when the vehicle is making a left turn. Unlike the example of FIG. 8A, the patterns 20a-20e in the image of FIG. 8B are asymmetrical with respect to left and right indicating that the vehicle is not moving straight forward. Further, the patterns in the image at the left side are denser (smaller distance between the patterns) than that at the right side, indicating that the vehicle is moving toward the left.

FIG. 8C illustrates an example motion image displayed in the interior of the vehicle when the vehicle is accelerating. The space between patterns 20c, 20d, 20e in the outer portion of the motion image, i.e. the patterns appearing closer or in proximity to the occupant is narrower than the spacing between patterns 20a, 20b in the inner portion of the motion image, i.e. the patters appearing farther from the vehicle occupant, and thereby simulates an increase in the vehicle's speed.

FIG. 8D illustrates an example motion image displayed in the interior of the vehicle when the vehicle is decelerating. In contrast to the example of FIG. 8C, the space between patterns 20d, 20e in the outer portion of the motion image, i.e. the patterns appearing closer or in proximity to the occupant is wider than the spacing between patterns 20a, 20b, 20c in the inner portion of the motion image, i.e. the patterns appearing farther from the vehicle occupant, and thereby simulates a decrease in the vehicle's speed.

FIG. 8E illustrates an example motion image displayed in the interior of the vehicle when the vehicle is moving downhill. Unlike the example of FIG. 8A, the patterns 20a-20e in the image of FIG. 8E are asymmetrical with respect to vertical orientation, i.e. the top edge of the patterns 20a-20c towards the center of the motion image have shorter widths than the bottom edges of the patterns, indicating that the vehicle is traversing a declining surface. Further, the patterns 20a-20e are densely distributed at the lower portion of the motion image, where the spacing between the bottom edges of the patterns is narrower than the spacing between the top edges of the patterns, which reinforces a simulated feeling to the vehicle occupant that the vehicle is moving downward. While not shown, the motion image representing the vehicle moving uphill can be similarly generated by reversing the up and down of FIG. 8E.

FIG. 8F illustrates an example motion image displayed in the interior of the vehicle when the vehicle is making a right turn, such as illustrated in FIGS. 5A-5B. The set of patterns 20a-20e in the example of FIG. 8F representing the right turn is a mirror image of the set of patterns of FIG. 8B representing a left turn. Specifically, the right edges of the patterns 20a-20e are densely distributed, with narrow separation of the patterns on the right side of the motion image, compared to the left edges of the patterns which are separated farther apart. Further in FIG. 8F, the motion image incorporates color and/or brightness changes in combination with the patterns, for example, the smaller, farther patterns 20a-20c are darker in color or brightness, whereas the larger closer patterns 20d-20e are brighter in color or darkness, or vice versa.

FIGS. 8G and 8H illustrate example motion images with patterns of increasing line weight proportional to the size of the pattern. In FIG. 8G, the smallest pattern 20a has the thinnest line weight, the next larger pattern 20b has a thicker line weight than pattern 20a, the next larger pattern 20c has a thicker line weight than pattern 20b, and the largest pattern 20d has the thickest line weight of the motion image. FIG. 8H similarly shows an example motion image with patterns of dotted lines with increasing line weight. The increase of line weight from thin to thick together with the increase in overall size of the pattern simulates how objects appear small when viewed from far away, and increase in size as they approach the viewer.

FIGS. 9A-9H are schematic diagrams showing another set of motion images of the present invention to be displayed in the interior of the vehicle. Each of the motion images illustrated in FIGS. 9A-9H is comprised of multiple rectangular patterns similar to those in FIGS. 8A-8F. In the examples of FIGS. 9A-9H, each motion image further includes perspective lines 77 to achieve more three-dimensional and realistic representation of the vehicle movements. Although the motion images in FIGS. 9A-9F, 9H include patterns of the same thickness in line weight, it is preferable that the line weight of each pattern is proportional to the size of the pattern as shown in FIG. 9G. In FIG. 9G, the smaller/farther pattern 20a has a thinner line weight compared to the next pattern 20b, which has a thicker line weight than the smaller/farther pattern 20a, but thinner than the next larger pattern 20c, and so on.

FIG. 9A illustrates an example motion image displayed in the interior of the vehicle when the vehicle is moving forward at a constant speed. Each pattern is longitudinally symmetric, and the separation between each pattern is maintained at a constant distance in order to convey the sense of constant forward motion to the occupant.

FIG. 9B illustrates an example motion image displayed in the interior of the vehicle when the vehicle is accelerating. The separation between each pattern 20a-20d is inversely proportional to the size/proximity of each pattern. For example, the separation 78C between the outermost pattern 20d and adjacent pattern 20c is smaller than the separation 78B between pattern 20c and pattern 20b. Likewise, the separation a between pattern 20b and 20a is larger than separation 78B. Thus the distribution of patterns from denser in close proximity to the occupant, to less dense for smaller patterns farther from the occupant indicates the increase in speed of the vehicle.

FIG. 9C illustrates an example motion image displayed in the interior of the vehicle when the vehicle is decelerating. In contrast to the example of FIG. 9B, the separation between each pattern 20a, 20b, 20c, 20d is directly proportional to the size/proximity of each pattern. For example, the separation 78C between the outermost pattern 20d and adjacent pattern 20c is larger than the separation 78B between pattern 20c and pattern 20b. Likewise, the separation a between pattern 20b and 20a is smaller than separation 78B. Thus the distribution of patterns from less dense in close proximity to the occupant, to denser for smaller patterns farther from the occupant indicates the decrease in speed of the vehicle.

FIG. 9D illustrates an example motion image displayed in the interior of the vehicle when the vehicle is moving uphill. The top edges of the patterns in the motion image are more tightly spaced than the lower edges of the patterns, and indicates that the vehicle is moving uphill.

FIG. 9E illustrates an example motion image displayed in the interior of the vehicle when the vehicle is moving downhill. The set of patterns is a mirror image of FIG. 9D with respect to the top edges and lower edges of the patterns, indicating that the vehicle is moving downward.

FIG. 9F illustrates an example motion image displayed in the interior of the vehicle when the vehicle is traversing rough driving conditions, such as unpaved roads, dirt roads, or other irregular conditions. The patterns in the motion image are oriented asymmetrically in both horizontal and vertical directions, indicating that the vehicle movements are irregular due to rough surfaces of the road.

FIG. 9G illustrates an example motion image displayed in the interior of the vehicle when the vehicle is making a left turn. The spacing between the left edges of each pattern is narrower whereas the spacing between the right edges of each pattern is wider, indicating that the vehicle is moving to the left.

FIG. 9H illustrates an example motion image displayed in the interior of the vehicle when the vehicle is making a sharp left turn. The patterns in the image of FIG. 9H show a higher degree of angle of the left turn than that of the normal left turn of FIG. 9G by, for example, the difference of the perspective lines 77 whose curves are opposite to one another in the left side and the right of the image.

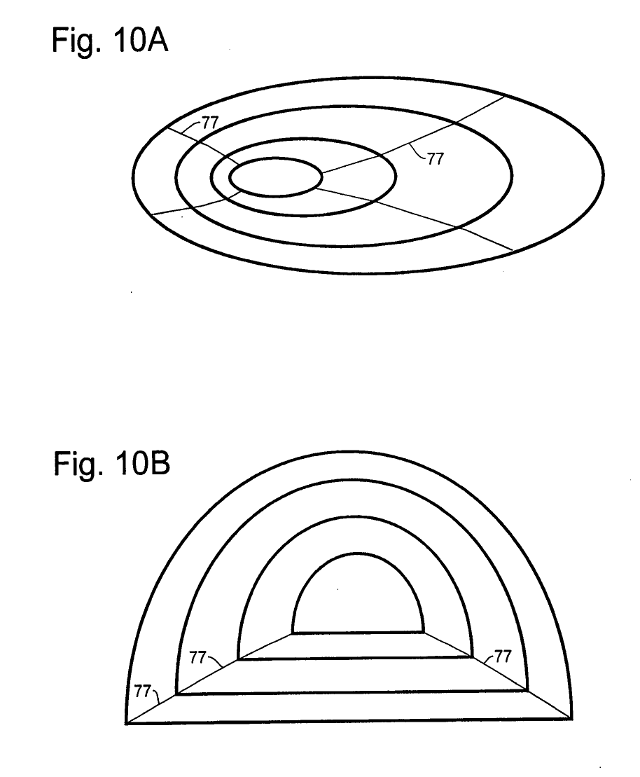

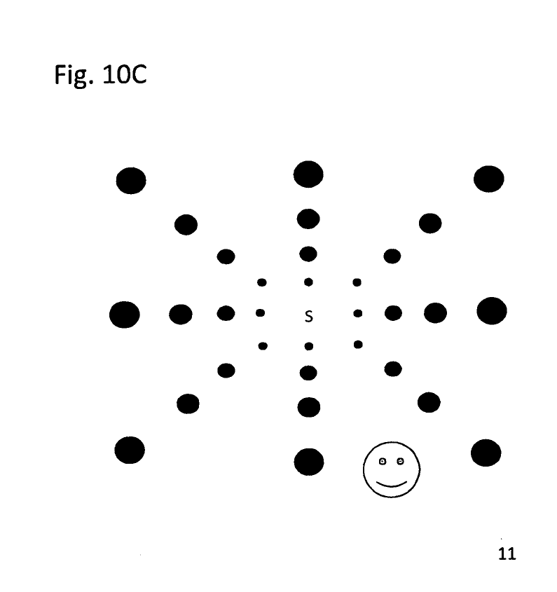

While the examples shown in FIGS. 8A-8F and 9A-9H display rectangular shape patterns to simulate motion through a tunnel, other shapes or patterns for forming the motion image may be used to provide motion cues to the occupant. FIGS. 10A, 10B and 10C are schematic diagrams showing further examples motion images of the present invention displayed in the vehicle interior. FIG. 10A shows a plurality of concentrically arranged patterns each having an oval shape displayed in a manner of perspective representation. FIG. 10B shows a plurality of concentrically arranged patterns each having a semi-circular shape displayed in a manner of perspective representation. FIG. 10C shows a plurality of ball shapes appearing to emerge or radiate from a singularity point S in a manner of perspective representation. Similar to the effect of increasing line weights shown in FIGS. 8G-8H, the ball shapes increase in size from the smallest shapes near the singularity point S, to the largest shape size at the periphery closer to the occupant 11. Although not shown, the motion image may also be formed by rows or patterns of other shapes or objects, such as trees, houses, etc.

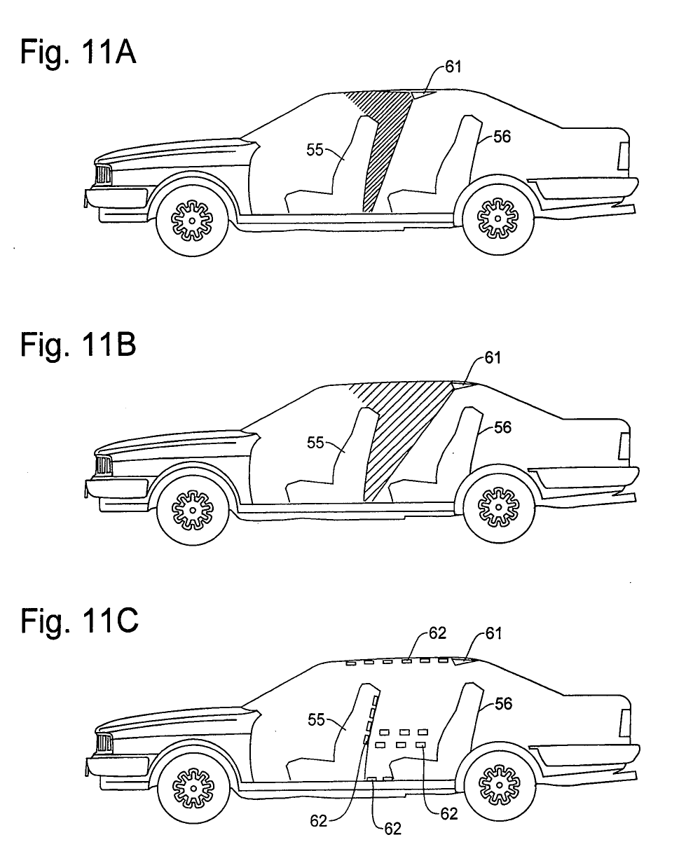

FIGS. 11A-11C are vehicle side views illustrating example positions for a display device and an image projected area to implement the method and apparatus for preventing motion sickness in the present invention. In FIG. 11A, a video projector 61 is mounted as a display device at an upper area of the vehicle such as a ceiling at about the midpoint between a front seat 55 and a back seat 56. The video projector 61 mounted on the ceiling can project the motion images in the vehicle interior such as on the interior surfaces such as on the back of the front seats 55. The video projector 61 also projects the motion images on the interior sidewalls or the floor to provide the visual message of the motion image to the occupant.

The position to mount the video projector 61 may be modified according to the inner vehicle configuration and the target area to project the motion image. For example, in FIG. 11B, the video projector 61 is mounted further back on the vehicle ceiling at about directly above the back seat 56. In the case of an automobile having a long body, such as a limousine or a bus, multiple video projectors 61 may be mounted to cover the longer or wider interior surfaces.

In FIG. 11C, a plurality of LEDs (Light Emitting Diodes) 62 are used as a display device on interior surfaces of the vehicle for displaying the motion images. LEDs 62 are mounted or embedded in lattice fashion, for example, on the back of the front seat 55, the floor of the vehicle, side walls and the ceiling of the vehicle, etc. The LEDs 62 may be used in place of the video projector 61 or may be used in combination with the video projector 61 to display the motion images of the present invention in areas where the motion images from the video projector 61 are unavailable.

While not shown, the motion images of the present invention may be displayed using virtual reality (VR) or augmented reality (AR) goggles, or other head or eye mounted devices, so that only vehicle occupants who are prone to motion sickness may view the motion images while other vehicle occupants will not view the motion images.

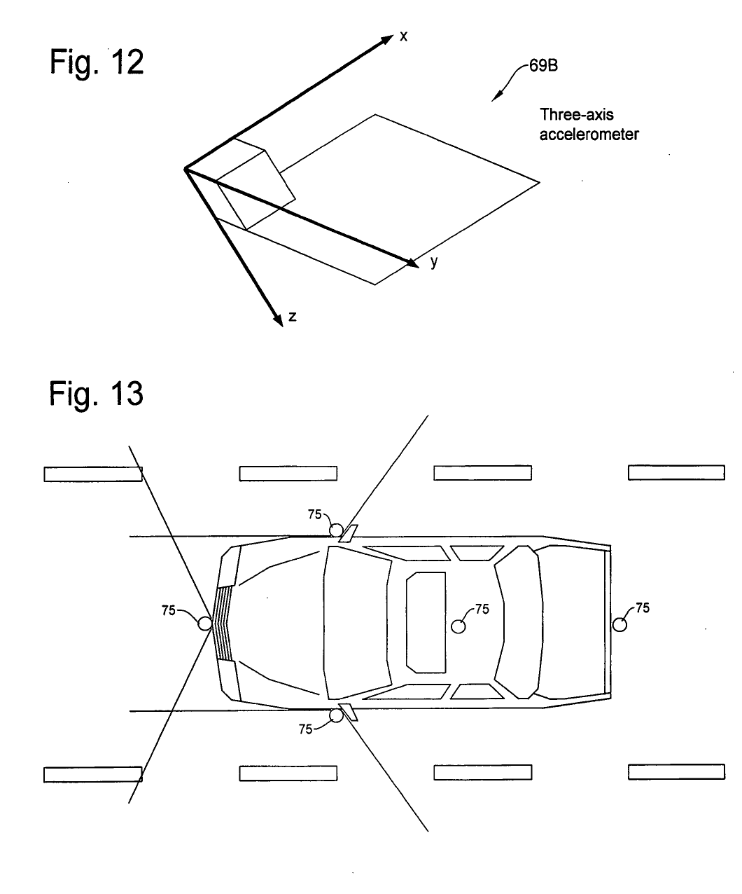

FIG. 12 is a schematic view showing an example of accelerometer 69B in the sensor unit 67 that can be implemented in the motion sickness prevention apparatus of the present invention. As noted above, this example is a triple-axis (three-axis) accelerometer typically made of MEMS (Micro-Electro-Mechanical Systems) technology. While MEMS-based accelerometers are preferable, any types of accelerometer may be used in the motion sickness prevention apparatus of the present invention. The accelerometer 69B may alternatively be comprised of one double-axis accelerometer and one single-axis accelerometer.

FIG. 13 is a top view of a vehicle mounting a plurality of cameras 75 that can be implemented in the motion sickness prevention apparatus of the present invention. In some cases, the motion image may be generated based on the vehicle movements detected by the IMU 69. The motion image may also be generated based on the video images captured by the cameras 75. Specifically, the video projector 61 may simply project the video images captured by the cameras 75 on the interior surfaces of the vehicle to provide visual cues to the occupants.

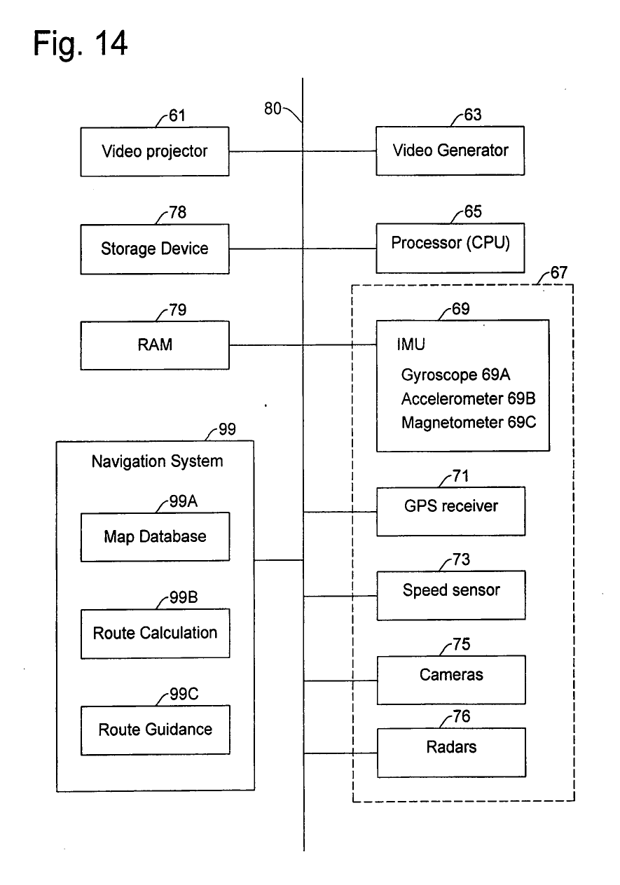

In the alternative, the video generator 63 described in FIG. 14 may generate the motion image by modifying the video images captured by the cameras 75 in real time. For instance, the video generator 63 may modify the video images captured by the cameras 75 to change the brightness of the images corresponding to weather, time of the day, etc. In still another alternative, the video generator 63 may modify the video images captured by the cameras 75 to heighten the contrast of the produced images.

FIG. 14 is a schematic block diagram showing an example of main components in the motion sickness prevention apparatus of the present invention. The block diagram of FIG. 14 includes a video projector 61 as a display device to project the motion image on the sidewall and/or the back of the front seats, etc., of the vehicle interior. As noted above with reference to FIG. 11C, a plurality of LEDs 62 may also be used as a display device. A video generator 63 is provided to generate the data of the motion image to be displayed by the video projector 61.

A sensor unit 67 is mounted on the vehicle to detect the vehicle location, moving condition, and objects in the surroundings, etc., by various sensors therein. The sensor unit 67 includes an inertial measurement unit (IMU) 69, a GPS (Global Positioning System) receiver 71, a speed sensor 73, a camera 75, and a radar 76. The IMU (inertial measurement unit) 69 is mounted on the vehicle to detect acceleration, deceleration and a moving direction of the vehicle. The IMU 69 may be comprised of a gyroscope 69A for detecting an angle, an accelerometer 69B for detecting acceleration and deceleration, and a magnetometer 69C for detecting a magnetic force. An example of accelerometer 69B is shown in FIG. 12 which is a triple-axis accelerometer.

Referring back to FIG. 14, the GPS receiver 71 receives and analyzes GPS signals from a plurality of GPS satellites to determine a current position of the vehicle. The speed sensor 73 detects the speed of the vehicle based on, for example, speed pulses of the vehicle to improve the accuracy of the current position. The camera 75 and the radar 76 may be mounted on the vehicle to obtain information on the surrounding of the vehicle such as roads, other vehicles, traffic signals, trees, buildings, pedestrians, etc., for not only generating the motion image of the present invention but also for safety and self-driving. The camera 75 may be mounted at on the exterior of the vehicle as illustrated in FIG. 13 in which several cameras 75 are mounted on the vehicle to capture wide views surrounding the vehicle.

A navigation system 99 comprises a map database 99A that stores map data for navigation, a route calculation module 99B that calculates a route from a start point to an end point in cooperation with the map database 99A and CPU 65, and a route guidance module 99C that generates maneuvers on a route calculated by the route calculation module 99B. The navigation system 99 receives signals from the sensor unit 67, such as vehicle speed, vehicle position and location, and vehicle surroundings in order to calculate maneuvers, provide route guidance, and for generation of motion images to prevent motion sickness.

Referring back to FIG. 14, a processor (CPU) 65 controls an overall operation of the method and apparatus of the present invention for preventing the motion sickness. The processor 65 receives the detected signals from the sensor unit 67, upcoming maneuvers on a route calculated by the route calculation module 99B based on road conditions from the map database 99A when available, and analyzes the sensor signals and maneuvers to determine the vehicle movements and the motion images corresponding to the vehicle movements. A storage device 78 stores various data and instructions, such as map data for vehicle navigation and self-driving and machine instructions configuring the programs for achieving the operational processes (see FIGS. 15, 16 and 17) of the present invention.

A RAM 79 is provided to read the data and machine instructions from the storage device 78. The data and machine instructions temporarily stored in the RAM 79 cause the processor 65 to carry out the operations of the present invention to determine the vehicle movements, upcoming maneuvers on a route calculated by the route calculation module 99B based on road conditions from the map database 99A and detected by external cameras 75, and to generate the motion image which will be displayed in the vehicle by the video projector 61. All of the functional elements described above are connected to a system bus 80 which will be further connected to a CAN (Control Area Network) bus of the vehicle for communication and control.

FIG. 15 is a flowchart showing basic operational steps of the motion sickness prevention method of the present invention, for vehicle motion along a calculated route, such as in FIGS. 6A-6B. In step 151, the processor 65 analyzes maneuver, route and map information from the navigation system 99, including from the map database 99A and route guidance module 99B, and road conditions such as weather, traffic, etc. detected by the sensor unit 67 such as from the cameras 75 and radars 76, to determine the upcoming vehicle movement. In step 152, the motion image data is generated by the video generator 63 based on the determined vehicle movements corresponding to the maneuver and road conditions. In step 153, the video projector 61 displays the motion image in the interior of the vehicle based on the data received from the video generator 63. In step 154, the vehicle actually traverses the maneuver after the motion image is displayed in the vehicle to the occupant. As described above, the generated motion images are immersive to the occupants of the vehicle and provide visual cues that inform the upcoming movements of the vehicle to provide the occupants a sense of visual and motional parity as well as sense of control.

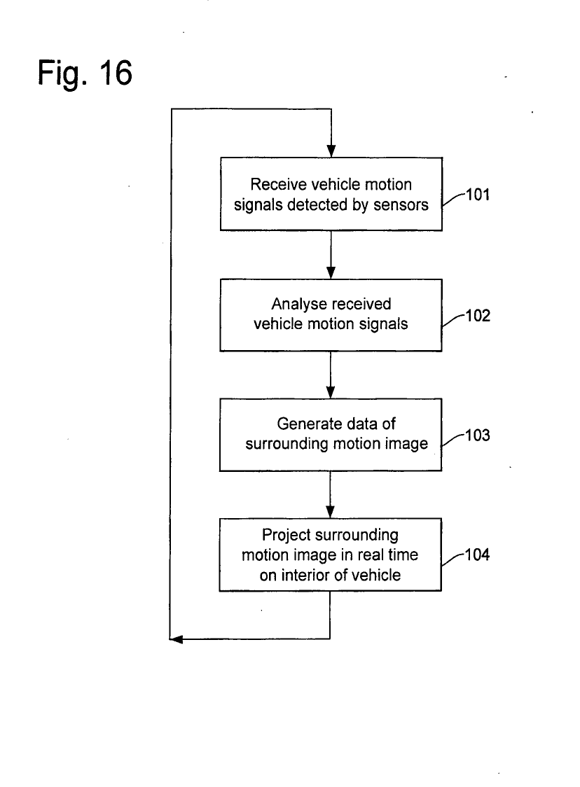

FIG. 16 is a flowchart showing basic operational steps of the motion sickness prevention method of the present invention, for vehicle motion not on a calculated route, such as under unexpected conditions shown in FIGS. 7A-7B. In step 101, the vehicle receives signals form the sensor unit 67, such as from the IMU (inertial measurement unit) 69. In step 102, the processor 65 analyses the received signals from the sensor unit 67 to determine the vehicle movement in real time, or to predict anticipated vehicle motion based on the received signals from the sensor unit 67. In step 103, the motion image data is generated by the video generator 63 based on the determined vehicle movements. In step 104, the video projector 61 displays the motion image in the interior of the vehicle based on the data received from the video generator 63. As described above, the generated motion images are immersive to the occupants of the vehicle and provide visual cues that inform the movements of the vehicle in real time, or the upcoming movements of the vehicle to provide the occupants a sense of visual and motional parity as well as sense of control.

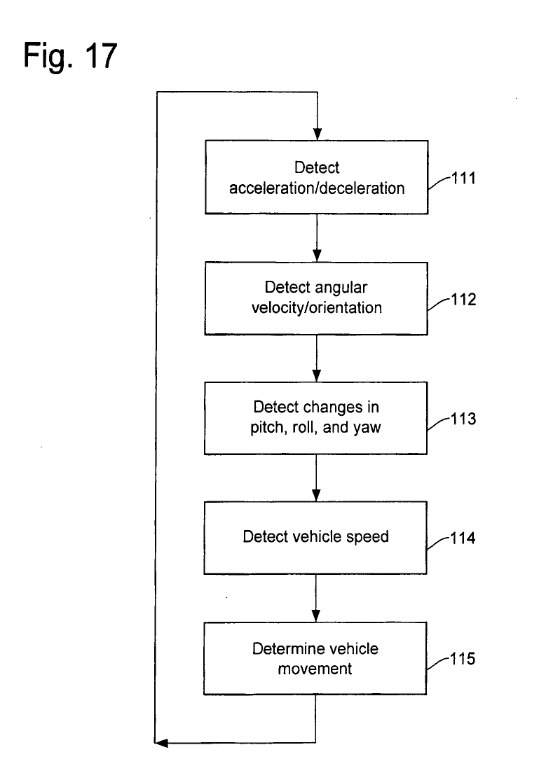

FIG. 17 is a flowchart showing detailed steps to determine the vehicle movement corresponding to steps 101 and 102 of the flowchart of FIG. 16. In step 111, the acceleration and deceleration of the vehicle is determined based on the signals detected by the accelerometer 69B. In step 112, the angular velocity and orientation are determined based on the signals detected by the gyroscope 69A. In step 113, the changes of pitch, roll and yaw are determined based on the detected signals from the gyroscope 69A, accelerometer 69B and magnetometer 9C. In step 114, the vehicle speed is detected by, for examples, the speed sensor 73. The order of operational steps described above may be varied or may be performed simultaneously. For instance, the step of determining the vehicle speed described in step 114 may be executed first rather than the step of determining the acceleration and deceleration. Based on the data obtained in steps 111-114, the processor 65 of the motion sickness prevention apparatus determines the vehicle motion in step 115.

As has been described above, according to the present invention, the method and apparatus for preventing motion sickness are designed to display motion image on an interior of a vehicle in a manner to convey visual feedback to occupants of the vehicle regarding the vehicle's current and upcoming movements. Such a motion image typically appears to surround the vehicle occupant, and includes a plurality of patterns concentrically arranged in a manner of perspective representation, e.g., as a three dimensional shape, or as a plurality of shapes or patterns emerging from a singularity, and changes the pattern in advance of upcoming vehicle movements. Thus, even though the occupants of the vehicle may not be paying attention to the vehicle movements but is rather, for example, reading a newspaper or viewing other media, the occupants can receive and process such moving patterns via their peripheral visions, and anticipate the upcoming vehicle movements, thereby enabling them to avoid motion sickness.

Although the motion sickness prevention method and apparatus of the present invention are described herein with reference to the preferred embodiment, one skilled in the art will readily appreciate that various modifications and variations may be made without departing from the spirit and scope of the present invention. Such modifications and variations are considered to be within the purview and scope of the appended claims and their equivalents.

What is claimed is:

1. A method for preventing motion sickness of an occupant of a vehicle, comprising:
calculating, by a central processing unit, a route guidance operation of a navigation unit for guiding a vehicle through a calculated route;
analyzing an upcoming maneuver on the calculated route;
generating, by a sensor unit, signals related to movements of the vehicle and conditions around the vehicle;
analyzing the signals from the sensor unit to determine movements of the vehicle;
producing data for displaying a motion image that provides three dimensional perspective cues to an occupant that represent the movements of the vehicle traversing the upcoming maneuver under the conditions in advance of the upcoming maneuver; and
displaying, by a display device, the motion image in the interior of the vehicle in advance of the vehicle traversing the upcoming maneuver to allow the occupant to anticipate the upcoming maneuver.

2. The method for preventing motion sickness as defined in claim 1, wherein the motion image includes a plurality of patterns of substantially identical shape and different sizes that are arranged concentrically.

3. The method for preventing motion sickness as defined in claim 2, wherein the plurality of patterns in the motion image dynamically increase their sizes to represent forward movements of the vehicle to create an image similar to that attained when going through a tunnel.

4. The method for preventing motion sickness as defined in claim 3, wherein the step of displaying the motion image includes a step of changing a width between two adjacent patterns in the motion image to display the movements of the vehicle in a manner of perspective representation.

5. The method for preventing motion sickness as defined in claim 4, wherein the step of displaying the motion image includes a step of decreasing the width between two adjacent patterns in the motion image at a side corresponding to a turning direction of the vehicle.

6. The method for preventing motion sickness as defined in claim 4, wherein the step of displaying the motion image includes a step of maintaining substantially the same width between two adjacent patterns in the motion image when the vehicle is moving in straight forward with a constant speed.

7. The method for preventing motion sickness as defined in claim 4, wherein the step of displaying the motion image includes a step of decreasing the width between two adjacent patterns at an outer area of the motion image when the vehicle is accelerating, and a step of increasing the width between two adjacent patterns at an inner area of the motion image when the vehicle is decelerating.

8. The method for preventing motion sickness as defined in claim 1, wherein the motion image includes a plurality of patterns that radiate from a common singularity.

9. The method for preventing motion sickness as defined in claim 1, further comprising a step of capturing outside views in front of the vehicle by a video camera, and wherein the motion image is comprised of images captured by the video camera.

10. The method for preventing motion sickness as defined in claim 1, wherein the display device is a video projector attached to an upper area of the vehicle or a plurality of LEDs formed on interior surfaces of the vehicle.

11. An apparatus for preventing motion sickness of an occupant of a vehicle, comprising:
a sensor unit that generates signals related to movements of the vehicle and conditions around the vehicle;
a processor that controls an overall operation of the apparatus; and
a display device to display images in an interior of the vehicle;
wherein said processor is configured to conduct the following operations of:
calculating a route guidance operation of a navigation unit for guiding a vehicle through a calculated route;
analyzing an upcoming maneuver on the calculated route;
analyzing the signals from the sensor unit to determine movements of the vehicle and conditions around the vehicle;
producing data for displaying a motion image that provides three dimensional perspective cues to an occupant that represent the movements of the vehicle traversing the upcoming maneuver under the conditions in advance of the upcoming maneuver; and
causing the display device to display the motion image in the interior of the vehicle in advance of the vehicle traversing the upcoming maneuver to allow the occupant to anticipate the upcoming maneuver.

12. The apparatus for preventing motion sickness as defined in claim 11, wherein the motion image includes a plurality of patterns of substantially identical shape and different size that are concentrically arranged therein.

13. The apparatus for preventing motion sickness as defined in claim 12, wherein the plurality of patterns in the motion image dynamically increase their sizes in response to forward movements of the vehicle to create an image similar to that attained when going through a tunnel.

14. The apparatus for preventing motion sickness as defined in claim 13, wherein the processor is configured to change a width between two adjacent patterns in the motion image to display the movements of the vehicle in a manner of perspective representation.

15. The apparatus for preventing motion sickness as defined in claim 14, wherein the processor is configured to decrease the width between two adjacent patterns in the motion image at a side corresponding to a turning direction of the vehicle.

16. The apparatus for preventing motion sickness as defined in claim 14, wherein the processor is configured to maintain substantially the same width between two adjacent patterns in the motion image when the vehicle is moving in straight forward with a constant speed.

17. The apparatus for preventing motion sickness as defined in claim 14, wherein the processor is configured to decrease the width between two adjacent patterns at an outer area of the motion image when the vehicle is accelerating, and increase the width between two adjacent patterns at an inner area of the motion image when the vehicle is decelerating.

18. The apparatus for preventing motion sickness as defined in claim 11, wherein the motion image includes a plurality of patterns that radiate from a common singularity.

19. The apparatus for preventing motion sickness as defined in claim 11, further comprising a video camera that captures outside views in front of the vehicle, and wherein the motion image is comprised of images captured by the video camera.

20. The apparatus for preventing motion sickness as defined in claim 11, wherein the display device is a video projector attached to an upper area of the vehicle or a plurality of LEDs formed on interior surfaces of the vehicle.
